(19) United States
(12) Patent Application Publication
(10) Pub. No.: US 2012/0269340 A1
(43) Pub. Date: Oct. 25, 2012

(54) HIERARCHICAL ENCRYPTION/DECRYPTION DEVICE AND METHOD THEREOF

(76) Inventors: Jay STU, Taipei City (TW); Yung-Sen Jang, Kaohsiung City (TW); Eddie Tsai, Taipei City (TW); Kuo-Tsang Huang, New Taipei City (TW)

(21) Appl. No.: 13/237,346

(22) Filed: Sep. 20, 2011

(30) Foreign Application Priority Data
Apr. 22, 2011 (TW) 100114008

(51) Int. Cl. H04L 9/28

(52) U.S. Cl. 380/28

(57) ABSTRACT

A hierarchical encryption device for decrypting a ciphertext and outputting a plaintext is disclosed in the invention, wherein the ciphertext comprises an encrypted block and a plurality of ciphertext blocks. The device comprises a first decryption unit, a generator and a second decryption unit. The second decryption unit is for decrypting the encrypted block by a secret key with a second decryption method to generate at least one index block and a plurality of confusion blocks. The generator is for generating a plurality of mask blocks according to the plurality of confusion blocks and the index block, wherein the number of the plurality of mask blocks is the same as that of the plurality of ciphertext blocks. The first decryption unit is for decrypting the plurality of ciphertext blocks by the plurality of mask blocks with a first decryption method to generate a plurality of plaintext blocks, wherein the number of the plurality of plaintext blocks is the same as that of the plurality of ciphertext blocks.

### CROSS REFERENCE TO RELATED APPLICATIONS

This application claims priority of Taiwan Patent Application No. 100114008, filed on Apr. 22, 2011, the entirety of which is incorporated by reference herein.

### BACKGROUND OF THE INVENTION

1. Field of the Invention

The present invention relates to the technical field of an encryption/decryption system and method for digital content, and in particular relates to a hierarchical encryption/decryption system and method for digital content.

2. Description of the Related Art

As technology developments, digital content such as images, music and videos are widely used in electronics apparatuses such as computer systems, smart phones and electronics book readers, allowing users to freely use different apparatuses to read digital content at any time. However, in the procedure for transmitting digital content, it is necessary to encrypt the digital content to prevent improper usage by other users.

Currently, there are two major types of encryption technologies for general data information. The first type is symmetric-key encryption and the second one is asymmetric-key encryption. In a symmetric-key encryption system, both the encryption end (transmission end) and the decryption end (reception end) need to use an identical secret key to perform encryption/decryption to the data. The advantage of symmetric-key encryption systems is fast for encryption/decryption, and it is hard to be cracked if the length of the secret key is long enough. However, the drawback is that a security mechanism is required to distribute the secret key to the encryption end and the decryption end. The widely used encryption/decryption standards in the world, such as AES, DES and 3DES are symmetric-key encryption algorithms. In asymmetric-key encryption systems, each user has a public key and a private key in pairs, wherein the public key can be distributed freely, and the private key should be kept confidentially. When digital content is encrypted by a key in a key pair, it is necessary to decrypt the digital content by another key in the key pair. The algorithms for asymmetric-key encryption systems are much more complicated, such that high confidentiality and verification can be provided. However, the drawback of the asymmetric-key encryption systems is lower performance compared with symmetric-key encryption systems, and the asymmetric-key encryption systems are often used on data having a shorter encryption length or digital signature. For example, DSS and ECC are widely used asymmetric-key encryption standards.

Because the capacities of the digital content data files are usually large, many electronic devices/systems use symmetric-key encryption algorithms to encrypt/decrypt the digital content. For example, although the widely used symmetric-key encryption standards such as AES and 3DES can provide secure data encryption to the digital content data files, it consumes a huge amount of resources and time when executing AES and 3DES by software. In particular, it takes a very long time for encryption/decryption on a low-performance device (e.g. hand-held devices using ARM or Qualcomm processors), and causes inconvenience for users. There is a solution provided by prior technology, which uses ASICs (application-specific integrated chip) in the low-performance device (e.g. hand-held devices) to increase the processing speed for encryption/decryption to reduce the processing time. However, the drawback of this solution is a higher cost due to the extra ASICs. If ASICs are not used due to cost issues, another solution is to simplify the encryption/decryption algorithm to reduce the processing time for encryption/decryption. Although the solution can reduce the processing time, the security for digital content is also decreased, and thus it can not prevent improper usage of the digital content by other users.

### BRIEF SUMMARY OF THE INVENTION

A detailed description is given in the following embodiments with reference to the accompanying drawings.

A hierarchical encryption method is provided in the invention. The method comprises the following steps of: receiving a plaintext, wherein the plaintext is subdivided into a plurality of plaintext blocks according to a specific amount of data; providing at least one index block, wherein the index block has a plurality of addresses and corresponding values, and the corresponding values of the plurality of addresses of the index blocks are randomly generated; providing a plurality of confusion blocks, wherein the confusion blocks have a plurality of addresses and corresponding values, and the corresponding values of the plurality of addresses of the confusion blocks are randomly generated; generating a plurality of mask blocks according to the confusion blocks and the index block, wherein the number of the plurality of mask blocks is the same as that of the plurality of plaintext blocks, and each of the plurality of mask blocks has the specific amount of data; encrypting the plurality of plaintext blocks by the plurality of mask blocks with a first encryption method to generate a plurality of ciphertext blocks, wherein the number of the plurality of ciphertext blocks is the same as that of the plurality of the plaintext blocks; encrypting the index block and the confusion blocks by a secret key with a second encryption method to generate an encrypted block; and outputting a ciphertext, wherein the ciphertext comprises the encrypted block and the plurality of ciphertext blocks.

In another embodiment, a hierarchical decryption method is provided. The method comprises the following steps of: receiving a ciphertext, wherein the ciphertext comprises an encrypted block and a plurality of ciphertext blocks; decrypting the encrypted block by a secret key with a second decryption method to generate at least one index block and a plurality of confusion blocks; generating a plurality of mask blocks according to the plurality of confusion blocks and the index block, wherein the number of the plurality of mask blocks is the same as that of the plurality of ciphertext blocks; decrypting the plurality of ciphertext blocks by the plurality of mask blocks with a first decryption method to generate a plurality of plaintext blocks, wherein the number of the plurality of plaintext blocks is the same as that of the plurality of ciphertext blocks; and outputting a plaintext, wherein the plaintext comprises the plurality of plaintext blocks.

In another embodiment, a hierarchical encryption device for encrypting a plaintext and outputting a ciphertext is provided, wherein the plaintext is subdivided into a plurality of plaintext blocks according to a specific amount of data. The device comprises: at least one index block, wherein the index block has a plurality of addresses and corresponding values, and the corresponding values of the plurality of addresses of the index block are randomly generated; a plurality of confusion blocks, wherein the plurality of confusion blocks have a plurality of addresses and corresponding values, and the corresponding values of the plurality addresses in each confusion block are randomly generated; a generator, for generating a plurality of mask blocks according to the index block and the plurality of confusion blocks, wherein the number of the plurality of mask blocks is the same as that of the plurality of plaintext blocks and each mask block has the specific amount of data; a first encryption unit, for encrypting the plurality of plaintext blocks by the plurality of mask blocks to generate a plurality of ciphertext blocks; and a second encryption unit, for encrypting the index block and the plurality of confusion blocks by a secret key with a second encryption method to generate an encrypted block, wherein the ciphertext comprises the encrypted block and the plurality of ciphertext blocks.

In yet another embodiment, a hierarchical decryption device for decrypting a ciphertext and outputting a plaintext is provided, wherein the ciphertext comprises an encrypted block and a plurality of ciphertext blocks. The device comprises: a second decryption unit, for decrypting the encrypted block by a secret key with a second decryption method to generate at least one index block and a plurality of confusion blocks; a generator, for generating a plurality of mask blocks according to the plurality of confusion blocks and the index block, wherein the number of the plurality of mask blocks is the same as that of the plurality of ciphertext blocks; and a first decryption unit, for decrypting the plurality of ciphertext blocks by the plurality of mask blocks with a first decryption method to generate a plurality of plaintext blocks, wherein the number of the plurality of plaintext blocks is the same as that of the plurality of ciphertext blocks.

### BRIEF DESCRIPTION OF THE DRAWINGS

The present invention can be more fully understood by reading the subsequent detailed description and examples with references made to the accompanying drawings, wherein:

FIG. 1A illustrates a block diagram of the hierarchical encryption device according to an embodiment of the invention;

FIG. 1B illustrates a block diagram of the hierarchical decryption device according to an embodiment of the invention;

FIG. 2 illustrates a diagram of various data blocks according to an embodiment of the invention;

FIG. 3 illustrates a diagram of a generator to generate mask blocks by at least one index block and confusion blocks according to an embodiment of the invention;

FIG. 4 illustrates a flow chart of the hierarchical encryption method according to an embodiment of the invention;

FIG. 5 illustrates a flow chart of the hierarchical decryption method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The hierarchical encryption/decryption device and method provided in the invention uses data blocks (including index blocks and confusion blocks) with random numbers to generate mask blocks. A first encryption unit uses a first encryption method to encrypt data (e.g. digital content) in accordance with the mask blocks, and a second encryption unit uses a second encryption method to encrypt the confusion blocks and the index blocks only. In an embodiment of the invention, the complexity of the second encryption method is higher than that of the first encryption method. That is, the first encryption method for encrypting data is a more simplified encryption algorithm, thereby increasing the encryption speed, and the second encryption method for encrypting the confusion blocks and index blocks is a complexity method such as symmetric-key encryption algorithm with higher security, which uses a private key for encryption to ensure security.

In an embodiment, the second encryption method in the hierarchical encryption/decryption device and method provided in the invention uses a symmetric-key encryption algorithm. In other words, both the encryption end and the decryption end have an identical secret key, and the encryption/decryption steps in the encryption/decryption ends are also symmetric. That is, the secret key is used in the encryption end to encrypt a plaintext to obtain an encrypted ciphertext, and the secret key is also used in the decryption end to recover the plaintext from the encrypted ciphertext.

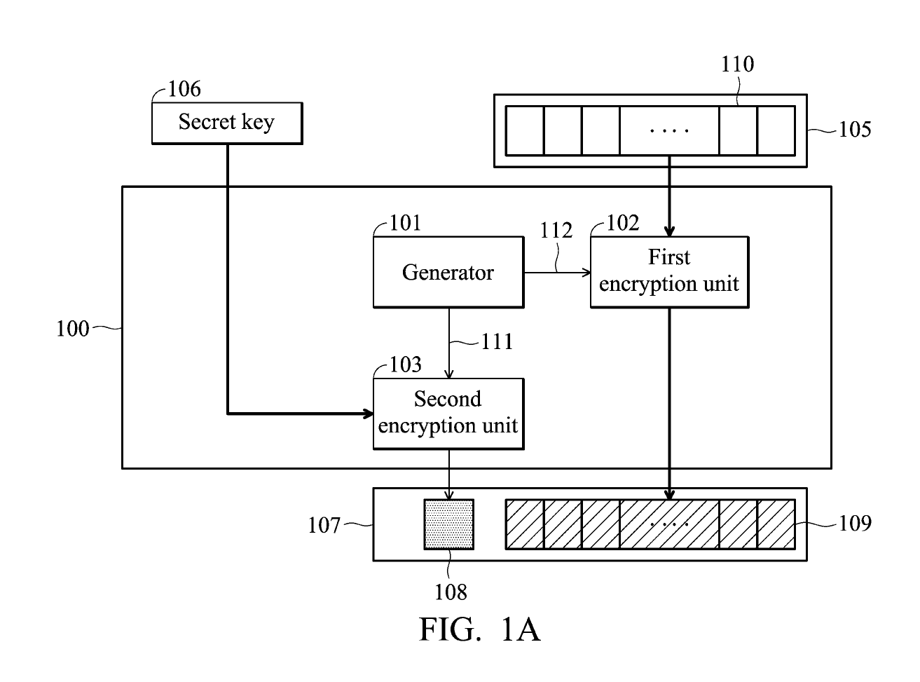

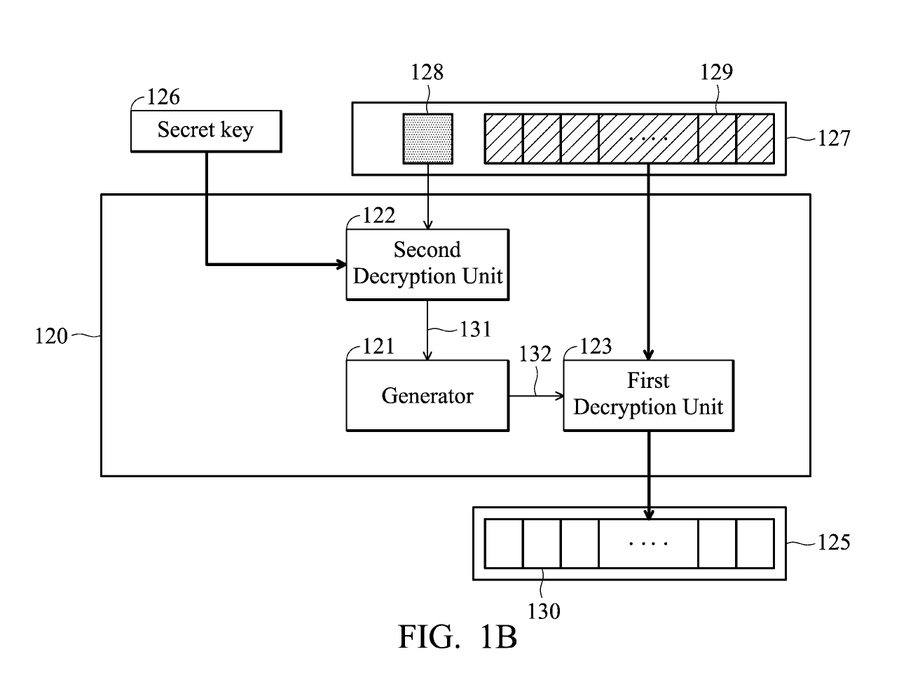

FIG. 1A illustrates a block diagram of the hierarchical encryption device according to an embodiment of the invention. FIG. 1B illustrates a block diagram of the hierarchical decryption device according to an embodiment of the invention. The hierarchical encryption device 100 comprises at least one index block, a plurality of confusion blocks, a generator 101, a first encryption unit 102 and a second encryption unit 103 to encrypt a plaintext 105 to generate a ciphertext 107, wherein the plaintext 105 is subdivided into a plurality of plaintext blocks 110 according to a specific amount of data Z. For example, the amount of data of each plaintext block is 4K bytes (e.g. Z can be other proper amount of data), and the number of the plaintext blocks which are subdivided is M, wherein the number M is an integer and a plural number. As illustrated in FIG. 1A, the generator 101 in the invention can generate a plurality of mask blocks 112 according to at least one index block and a plurality of confusion blocks, wherein the number of the mask blocks is the same as that of the plaintext blocks, such as M, and each mask block has the specific amount of data Z (e.g. 4K bytes). Each of the index block and confusion blocks has a plurality of addresses and corresponding values. Further, the corresponding values in the plurality of addresses in each of the index block and the confusion blocks are also randomly generated, which can be generated dynamically by random numbers or non-random numbers. By combining at least one index block and a plurality of confusion blocks, a confusion index block can be obtained as the secret parameter 111 in the second encryption unit 103. In some embodiments, the index block and the confusion blocks can be set and stored in advance, while in some other embodiments, the index block and the confusion blocks can be generated dynamically by the generator 101 at random. The first encryption unit 102 uses the mask block 112 to encrypt the plaintext blocks 110 by the first encryption method to generate a plurality of ciphertext blocks 109, wherein the number of ciphertext blocks 109 is the same as that of the plaintext blocks 110. The second encryption unit 103 uses a secret key 106 to encrypt the secret parameter 111 (e.g. confusion blocks and at least one index block) to generate the encrypted block 108. Further, the number of mask blocks 112 is the same as that of the plaintext blocks 110, and the first encryption unit 102 uses one of mask blocks to encrypt one of plaintext blocks sequentially and separately to generate the ciphertext block. For example, the first encryption unit 102 uses the first mask block to encrypt the first plaintext block to generate the first ciphertext block, and uses the second mask block to encrypt the second plaintext block to generate the second ciphertext block and so on, until all plaintext blocks are encrypted.

In some embodiments, in the method for generating mask blocks according to the confusion blocks and the at least one index block, the corresponding value in each different address in the index block is calculated by a formula to generate a value to serve as an operation address for each confusion block. Each of the corresponding values in each confusion block is retrieved according to the calculated operation address, and the retrieved corresponding value is calculated by a specific formula to generate a first value in each mask block respectively.

In an embodiment, the secret key 106 can be received through external communications connections, pre-stored in a storage unit connected with the hierarchical encryption device (not shown in FIG. 1A), or stored in a storage device (e.g. a hard disk, a USB disk or a thumbnail portable-disk) kept by a user. The secret key 106 can also be strings, numbers, data, or files inputted from an input interface (not shown in FIG. 1A). In another embodiment, the second encryption unit 103 can use prior well-known standard encryption/decryption algorithms, such as AES and 3DES algorithms, or other encryption/decryption algorithms with higher security, to generate an encrypted block 108, but the invention is not limited thereto.

In an embodiment, the plaintext 105 can be a multimedia bitstream, a text, a sound, or a video bitstream. The ciphertext 107 includes the encrypted block 108 and the ciphertext block 109. In a better embodiment, the encryption algorithm in the second encryption unit 103 is more complex than that in the first encryption unit 102. That is, a standard encryption/decryption algorithm with more complexity and higher security can be used in the second encryption unit 103 to encrypt the confusion blocks and index blocks to increase the encryption security. However, a simplified encryption/decryption algorithm with higher performance can be used in the first encryption unit 102, and the mask blocks 112 can be used to encrypt the plaintext block 110, thereby obtaining fast computing efficiency. Overall, the encryption security is equal to the standard encryption/decryption algorithm used in the second encryption unit 103.

As illustrated in FIG. 1B, in an embodiment, the hierarchical decryption device 120 comprises a generator 121, a second decryption unit 122 and a first decryption unit 123 to decrypt a ciphertext 127 to generate a plaintext 125, wherein the ciphertext 127 comprises a plurality of ciphertext blocks 129 and an encrypted block 128. During the decryption process, the second decryption unit 122 uses a secret key 126 to decrypt the encrypted block 128 by a second decryption method to obtain a secret parameter 131, wherein the secret parameter 131 comprises at least one index block and a plurality of confusion block. Further, the at least one index block and confusion blocks have a plurality of addresses and corresponding values as mentioned above, and some corresponding values of the plurality of addresses are randomly generated.

The encrypted block 128 is generated by a second encryption method corresponding to the second decryption method. For example, when the second decryption method is the AES or 3DES algorithm, the encrypted block 128 is the block encrypted by the AES or 3DES algorithm. That is, the second decryption method used in the second decryption unit 122 corresponds to the encryption method used in the encrypted block 128. For example, when the encrypted block 128 is encrypted by the second encryption method in the embodiment mentioned above, the encrypted block 128 is decrypted by the second decryption method corresponding to the second encryption method. Hereafter, the generator 121 generates a plurality of mask blocks 132 by the secret parameter 131 (e.g. at least one index block and a plurality of confusion blocks), wherein the number of the confusion blocks is the same as that of the ciphertext blocks. In an embodiment, the secret key 126 can be received through communications connections, pre-stored in a storage unit connected with the hierarchical decryption device (not shown in FIG. 1B), or stored in a storage device (e.g. a hard disk, a USB disk, or a thumbnail portable-disk) kept by a user. The secret key 106 can also be strings, numbers, data, or files inputted from an input interface (not shown in FIG. 1B). The first decryption unit 123 further uses the mask blocks generated by the generator 121 (e.g. the generating method is the method mentioned above) to decrypt the ciphertext blocks 129 by the first decryption method to obtain plaintext blocks 130, wherein the number of plaintext blocks 130 is the same as that of the ciphertext blocks 129. The complete plaintext 125 can be obtained by combining all the plaintext blocks 130. The first decryption unit 123 uses one mask block to decrypt each ciphertext block sequentially and separately. For example, the first mask block is used to decrypt the first ciphertext block to generate the first plaintext block, and the second mask block is used to decrypt the second ciphertext block to generate the second plaintext block, and so on, until all ciphertext blocks are decrypted.

The ciphertext block 129 is encrypted by the first encryption method corresponding to the first decryption method. For example, when the first decryption method is a simplified encryption/decryption algorithm, the ciphertext blocks 129 are blocks encrypted by the simplified algorithm. In another example, when the ciphertext blocks 129 is encrypted by the first encryption method in the embodiment mentioned above, the corresponding decryption method corresponding to the first encryption method is used in the first decryption method.

In the embodiments mentioned above, the components in the hierarchical encryption device 100 and the hierarchical decryption device 120, such as the generator 101, the first encryption unit 102, the second encryption unit 103, the first decryption unit 123, and the second decryption unit 122, can be implemented by a processor, a chip, a computer, a server, or other computing devices capable of performing calculations, and some or all components can be integrated into the processor, the chip, the computer or the server. Further, the hierarchical encryption device 100 and the hierarchical decryption device 120 further comprise at least one storage unit, such as a hard disk, a diskette, a portable disk, a tape, a memory, a CD or DVD disc, for storing the plaintext (e.g. 105 and 125), and the ciphertext (e.g. 107 and 127), and all the plaintext and ciphertext can be stored into the same storage unit alternatively.

In yet another embodiment, the hierarchical encryption device 100 and the hierarchical decryption device 120 can be two separate devices, and thus they can be set at different places to encrypt and decrypt data separately. However, in another embodiment of the invention, the hierarchical encryption device 100 and the hierarchical decryption device 120 can be integrated into one device, and thus the integrated device can perform both encryption and decryption. For example, the generator 101 in the hierarchical encryption device 100 and the generator 121 in the hierarchical decryption device 120 are integrated. Similarly, the first encryption unit 102 and the first decryption unit 123 can be integrated into a first encryption/decryption unit (not shown in FIGS. 1A and 1B). Likewise, the second encryption unit 103 and the second decryption unit 122 can be integrated into a second encryption/decryption unit (not show in FIGS. 1A and 1B). The first encryption unit 102 in the hierarchical encryption device 100 and the first decryption unit in the hierarchical decryption device 120 can be replaced by the first encryption/decryption unit, while the second encryption unit 103 in the hierarchical encryption device 100 and the second decryption unit 122 in the hierarchical decryption device 120 can be replaced by the second encryption/decryption unit. During the encryption procedure in the embodiment, the first encryption/decryption unit can use mask blocks to encrypt the plaintext blocks by the first encryption/decryption method to generate a plurality of ciphertext blocks, and the second encryption/decryption unit can use the secret key 106 to encrypt the index block and the confusion blocks (e.g. confusion index blocks) by the second encryption/decryption method to generate the encrypted block 108. During the decryption procedure, the second encryption/decryption unit uses the secret key 106 to decrypt the encrypted block 108 by the second encryption/decryption method to generate the index block and the confusion blocks, and the generator 121 can generate a plurality of mask blocks according to the index block and the confusion blocks, wherein the confusion index block can be obtained by combining the index block and the confusion blocks. The first encryption/decryption unit uses the mask blocks generated by the second encryption/decryption unit to decrypt the ciphertext blocks by the first encryption/decryption method to generate and output the plaintext blocks.

In yet another embodiment, the hierarchical encryption device 100 and the hierarchical decryption device 120 can be alternatively integrated into another encryption/decryption device for encryption and decryption. For example, the generator 101 in the hierarchical encryption device 100 and the generator 121 in the hierarchical decryption device 120 are integrated into an encryption/decryption generator, and the encryption/decryption device further comprises the encryption/decryption generator, the first encryption unit 102, the first decryption unit 123, the second encryption unit 103 and the second decryption unit 122 (not shown in FIGS. 1A and 1B).

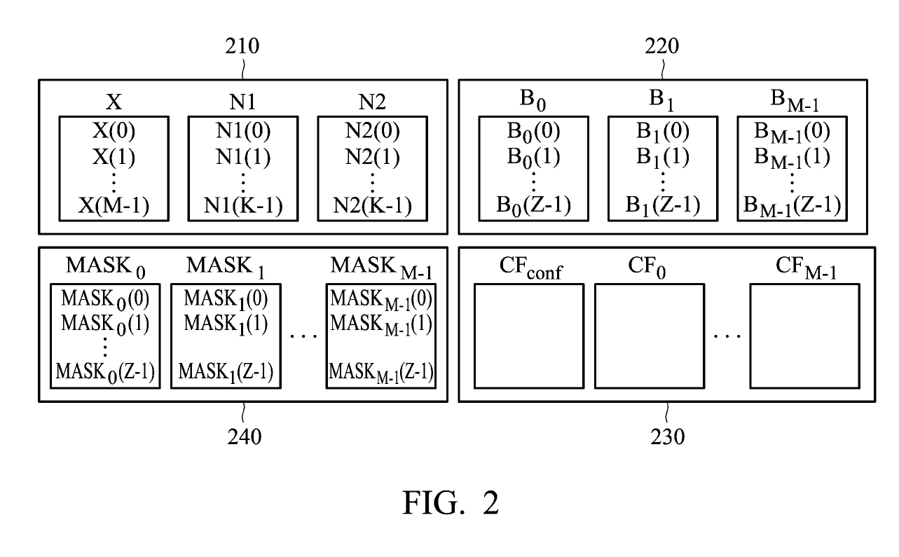

FIG. 2 illustrates a diagram of various data blocks according to an embodiment of the invention. In a better embodiment, as illustrated in FIG. 2, the confusion index block 210 comprises an index block X and two confusion blocks N1 and N2, but the invention is not limited thereto. In another embodiment, two index blocks can be used in the confusion index block (e.g. X1 and X2). There are a plurality of addresses and corresponding values in the index block X and the confusion blocks N1 and N2 respectively, wherein the corresponding values are random numbers. In an embodiment, while using two index blocks X1 and X2, the number of addresses and corresponding values can be different between the index blocks X1 and X2. Generally, more different between the data in the index blocks X1 and X2 and more amount of data in the index blocks X1 and X2, lower the chances to generate repeated mask blocks. Thereby the chances to be found the encryption rule is reduced and the encryption/decryption device is hard to cracked by other users.

The plaintext 220 can be subdivided into a number M of plaintext blocks B₀ to B_{M-}1 according to a specific amount of data Z. In an embodiment, the least size of the plaintext data blocks B₀ to B_{M-}1 can be 1 bit, which means, the specific amount of data Z can be 1 bit. The size of the last plaintext block B_{M-}1 may be smaller than or equal to Z. In a better embodiment of the invention, the amount Z of plaintext blocks B₀ to B_{M-}1 is 4096 bytes. The ciphertext 230 comprises an encrypted block CF_{conf} and a number M of ciphertext blocks CF₀ to CF_{M-}1. The mask blocks 240 comprise mask blocks MASK₀ to MASK_{M-}1, wherein the number of mask blocks is M and the amount of data of each mask block is Z.

In the better embodiment, the amount of data in the index block X is larger than or equal to the number M of the plaintext blocks and is smaller than 256×256 bytes, but the invention is not limited thereto. There is a plurality of addresses and corresponding values in the index block X, wherein the corresponding values are integers between 0 to 255, which are randomly generated (i.e. each corresponding value is different from each other in the index block X). If the amount of data in the index block X is smaller than M, the corresponding values in the index block X can be used repeatedly. In the embodiment, the amount of data in the index block X is M, that is, X={X(0)·X(1) . . . X(M−1)}.

The number of confusion blocks is at least two, and the confusion blocks are N1 and N2 in the embodiment. There is also a plurality of addresses and corresponding values in the confusion blocks N1 and N2, wherein the corresponding values are integers between 0 to 255, which are randomly generated (i.e. each corresponding value is different from each other in the confusion blocks N1 and N2). The amount of data in the index block X and confusion blocks N1 and N2 can be identical, partially identical, or different. In the embodiment, the amount of data in the confusion blocks N1 and N2 is K, that is, N1={N1(0)·N1(1) . . . N1(K−1)} and N2={N2(0)·N2(1) . . . N2(K−1)}.

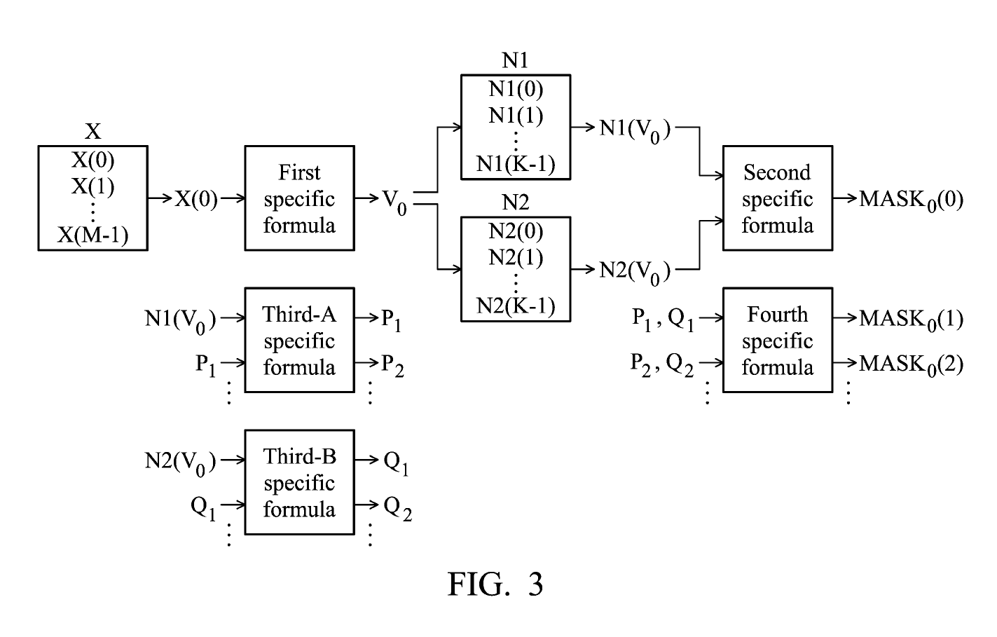

FIG. 3 illustrates a diagram of a generator to generate mask blocks by at least one index block and confusion blocks according to an embodiment of the invention. The corresponding value of each different address in the index block is calculated by a formula to serve as an operation address for each confusion block, and the corresponding values of the operation addresses for each confusion block are obtained according to the operation addresses, and the corresponding values in each confusion block are calculated to generate a first value of each mask block by a specific formula. The details will be explained below.

As illustrated in FIG. 1A (or FIG. 1B), FIG. 2 and FIG. 3, referring to the embodiment as shown in FIG. 2, when the generator 101 (or 121) generates a corresponding value of the address 0 in the n^{th} mask block MASKₙ, the generator 101 calculates, using a first specific formula to generate to obtain a value Vₙ (e.g. Vₙ=[X(n)×C1+X(n+1)]% K, wherein n is the mask block number of the mask block, C₁ is a specific constant (such as 256) which can be set upon need). In the embodiment, the corresponding value of address 0 and the next address (e.g. address 1) are used to calculate a value in the first specific formula, and a residue can be obtained from the calculated value according to the number K of confusion blocks, but the invention is not limited thereto. In some other embodiments, the first specific formula can be Vₙ=[X(n)×C1+X(n+1)+C2]% K, Vₙ=[X(n)×C1+X(n+2)]% K or other appropriate formulas. Generally, the encryption security of the application increases as the first specific formula gets more complex.

In the embodiment, when calculating the corresponding value of address 0 in the mask block MASK₀, the value V₀=[X(0)×C1+X(1)]% K. Next, the value V₀ is regarded as the address in the confusion blocks N1 and N2, and the corresponding values of address V₀ in the confusion blocks N1 and N2 is retrieved from the confusion blocks N1 and N2, respectively (e.g. N1(V₀) and N2(V₀)). The retrieved values is calculated with a second specific formula, and the calculated value can be regarded as the corresponding value of address 0 in the mask block MASK₀. The second formula can be an XOR operation or other appropriate formulas, such as MASKₙ(0)=N1(Vₙ)⊕N2(Vₙ).

In the embodiment, when the number n is equal to 0, the value MASK₀(0)=N1(V₀)⊕N2(V₀). When the generator 101 (or 121) retrieves the corresponding value of address 0 in the mask block MASK₀ and generates the corresponding value of a next address in the mask block MASK₀ (e.g. MASK₀(1)), the retrieved values of address V₀ in the confusion blocks N1 and N2 can be used (e.g. N1(V₀) and N2(V₀)), and the retrieved values can be calculated by a third-A specific formula and a third-B specific formula, respectively. The calculated values can be regarded as new addresses P₁ and Q₁ in the confusion blocks N1 and N2, respectively, and the corresponding values of the new addresses can be obtained (e.g. N1(P₁) and N2(Q₁)). Further, the value of MASK₀(1) can be calculated by a fourth specific formula. The fourth specific formula is similar to the second specific formula, wherein N1(Pᵢ) replaces N1(V₀), and N2(Qᵢ) replaces N2(V₀), such as MASK₀(i)=N1(Pᵢ)⊕N2(Qᵢ).

The calculation of the third-A specific formula and the third-B specific formula can be identical to the first specific formula or not. In the embodiment, the third-A specific formula, for example, can be Pᵢ₊₁=[N1(Pᵢ)×C3+N1(Pᵢ+1)]% K, and the third-B specific formula, for example, can be Qᵢ₊₁=[N2(Qᵢ)×C3+N2(Qᵢ+1)]% K, wherein C3 is a specific constant and can be set upon need, such as 256, but the invention is not limited thereto.

The third-A, third-B and fourth specific formula can be use repeatedly to calculate the values MASK₀(1), MASK₀(2), . . . , and MASK₀(Z−1), and thus the mask block MASK₀ can be obtained. Next, the number n can change from 1 to M−1, and all the steps in FIG. 3 can be repeated by using the corresponding values of address 1 to M−1 in the index block X until all the mask blocks are obtained (e.g. MASK₀, MASK₁, . . . , MASK_{M-}1).

Further, the first encryption unit 102 can encrypt the plaintext block B0 by using the mask block MASK₀ and the first encryption method (e.g. XOR) to generate the corresponding ciphertext block CF₀, and encrypt the plaintext block B1 to obtain the corresponding ciphertext block CF₁, and so on, until the ciphertext blocks CF₁ to CF_{M-}1 are obtained. Alternatively, the confusion index block 210 is encrypted by a secret key with the second encryption method, such as well-known standard encryption/decryption algorithms AES or 3DES, to obtain the encrypted block CF_{conf}, wherein the size of the confusion index block should be larger than or equal to the length of the secret key. For example, the length of a secret key in the 3DES encryption/decryption algorithm can be 112 bits or 168 bits, and the length of a secret key in the AES encryption/decryption algorithm can be 128 bits, 192 bits or 256 bits. The aforementioned embodiment explains how to use an index block and two confusion blocks to generate mask blocks, but the invention is not limited thereto. For example, in an embodiment, the hierarchical encryption/decryption device may have two index blocks (e.g. X1 and X2) and two confusion blocks. That is, the corresponding values of each address in the index blocks are calculated by the first specific formula to obtain the value V₀ of each confusion block. That is, the value V₀=[X1(0)×C1+X1(1)] % K in the confusion block N1, and the value V₀=[X2(0)×C1+X2(1)]% K in the confusion block N2.

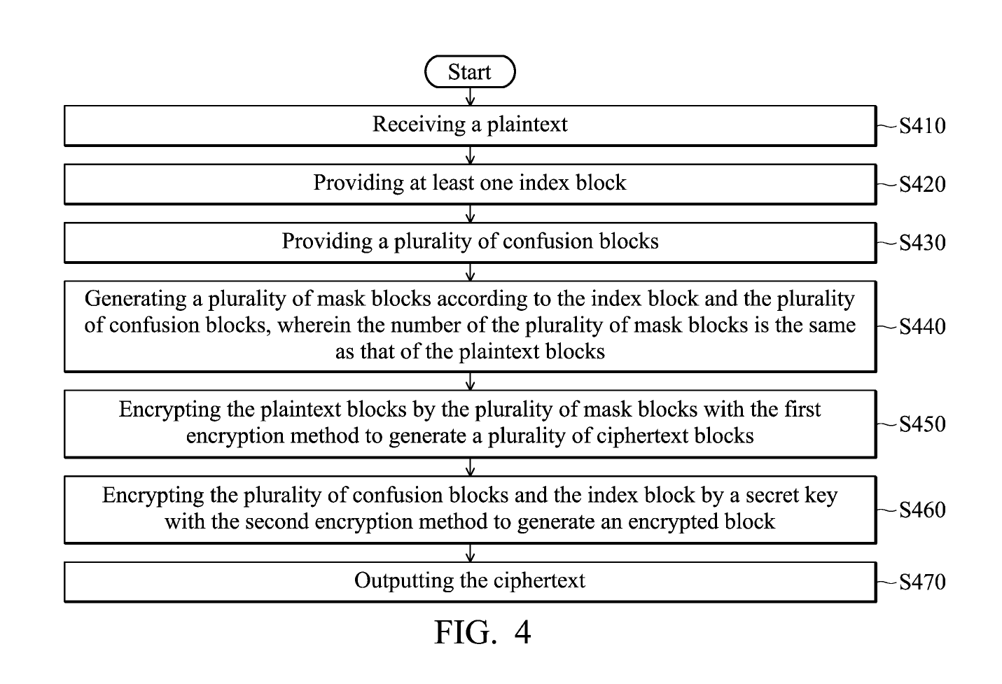

FIG. 4 illustrates a flow chart of the hierarchical encryption method according to an embodiment of the invention. The hierarchical encryption method can be executed by the hierarchical encryption device 100, which comprises the generator 101, the first encryption unit 102, and the second encryption unit 103, and these components can be implemented by a processor, a chip, a computer, a server, or any other computing device capable of performing calculations. In step S410, the hierarchical encryption device 100 receives the plaintext 105, wherein the plaintext 105 is subdivided in to the number M of plaintext blocks 110 according to a specific amount of data. In step S420, the hierarchical encryption device 100 provides at least one index block, wherein there is a plurality of addresses and corresponding values in the index block and the corresponding values are randomly generated. In step S430, the hierarchical encryption device 100 provides a plurality of confusion blocks, wherein there is a plurality of addresses and corresponding values in the confusion blocks and the corresponding values are randomly generated. In addition, the hierarchical encryption device 100 further comprises a storage unit, wherein the plaintext, the ciphertext, the index blocks and the confusion blocks can be stored in the storage unit. In step S440, the generator 101 generates a plurality of mask blocks 112 according to the confusion blocks and the index block, wherein the number of the mask blocks is the same as that of the plaintext blocks and each mask block 112 have the specific amount of data. In step S450, the first encryption unit 102 encrypts the plaintext blocks 110 by the confusion blocks 112 with the first encryption method to generate a plurality of ciphertext blocks 109, wherein the number of ciphertext blocks is the same as that of the plaintext blocks 110. In step S460, the second encryption unit 103 encrypts the confusion blocks and the index block by the secret key 106 with the second encryption method to generate an encrypted block 108. In step S470, the hierarchical encryption device 100 outputs the ciphertext 107, wherein the ciphertext 107 comprises the encrypted block 108 and the ciphertext blocks 109. The secret key 106 can be received through external communications connections, pre-stored in a storage unit connected with the hierarchical encryption device, or stored in a storage device (e.g. a hard disk, a USB disk, or a thumbnail portable-disk) kept by a user. The secret key 106 can also be strings, numbers, data, or files inputted from an input interface (not shown in FIG. 1A).

When the hierarchical encryption device 100 and the hierarchical decryption device 120 are integrated into one device, it indicates that the generator 101 in the hierarchical encryption device 100 and the generator 121 in the hierarchical decryption device 120 are integrated into a generator, and the first encryption unit 102 and the first decryption unit 123 are integrated into a first encryption/decryption unit, and the second encryption unit 103 and the second decryption unit 122 can be integrated into a second encryption/decryption unit. The encryption method further includes the following decryption steps. First, the second encryption/decryption unit decrypts the encrypted block 108 by a secret key (e.g. inputted or provided during decryption) with the second decryption method corresponding to the second encryption method, to obtain the index block and confusion blocks. Second, the generator generates a plurality of mask blocks according to the decrypted index blocks and confusion blocks, wherein the number of mask blocks is the same as that of the plaintext blocks. Last, the first encryption/decryption unit decrypts the ciphertext blocks 109 by the mask blocks generated by the generator with the first decryption method corresponding to the first encryption method to obtain and output the plaintext blocks.

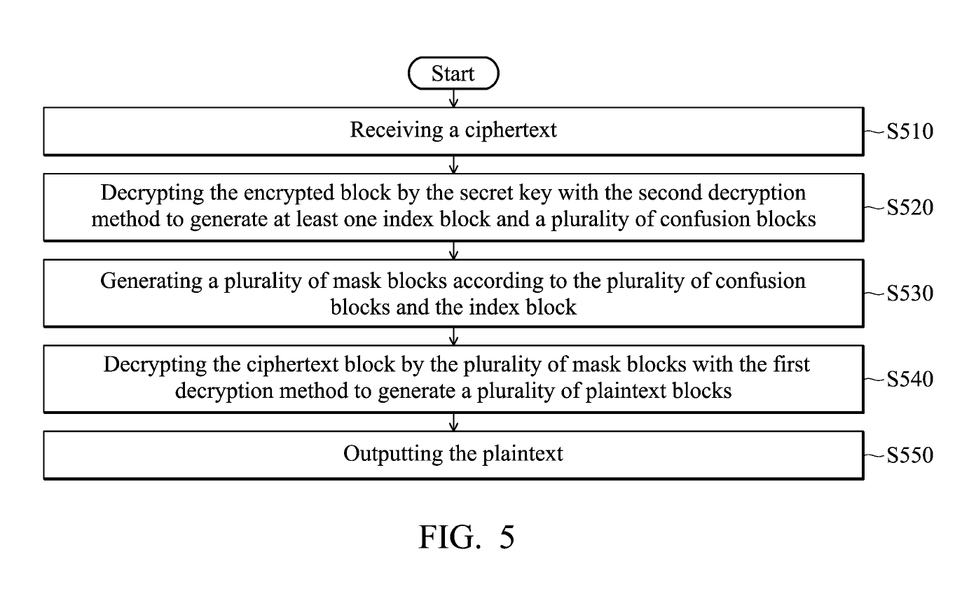

FIG. 5 illustrates a flow chart of the hierarchical decryption method according to an embodiment of the invention. The hierarchical decryption method can be executed by the hierarchical decryption device 120, which comprises the generator 121, the first decryption unit 123 and the second decryption unit 122, and these components can be implemented by a processor, a chip, a computer, a server or any other computing devices capable of performing calculations. In step S510, the hierarchical decryption device 120 receives the ciphertext 127, wherein the ciphertext 127 comprises an encrypted block 128 and a plurality of ciphertext blocks 129. In step S520, the second decryption unit 122 decrypts the encrypted block 128 by the secret key 126 with the second decryption method to generate at least one index block and a plurality of confusion blocks. In step S530, the generator 121 generates a plurality of mask blocks 132 according to the confusion blocks and the index block, wherein the number of mask blocks is the same as that of the ciphertext blocks 129. In step S540, the first decryption method 123 decrypts the ciphertext blocks 129 by the mask blocks 132 with the first decryption method to generate a plurality of plaintext blocks 130, wherein the number of the plaintext blocks 130 is the same as that of the ciphertext blocks 129. In step S550, the hierarchical decryption device 120 outputs the plaintext 125, wherein the plaintext 125 comprises the plurality of plaintext blocks 130. In addition, the hierarchical decryption device 120 further comprises a storage unit, and the plaintext, the ciphertext, the index block, and the confusion blocks can be stored in the storage unit.

The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hierarchical encryption method, comprising
receiving a plaintext, wherein the plaintext is subdivided into a plurality of plaintext blocks according to a specific amount of data;
providing at least one index block, wherein the index block has a plurality of addresses and corresponding values, and the corresponding values of the plurality of addresses of the index blocks are randomly generated;
providing a plurality of confusion blocks, wherein the confusion blocks have a plurality of addresses and corresponding values, and the corresponding values of the plurality of addresses of the confusion blocks are randomly generated;
generating a plurality of mask blocks according to the plurality of confusion blocks and the index block, wherein the number of the plurality of mask blocks is the same as that of the plurality of plaintext blocks, and each mask block has the specific amount of data;
encrypting the plurality of plaintext blocks by the plurality of mask blocks with a first encryption method to generate a plurality of ciphertext blocks, wherein the number of the plurality of ciphertext blocks is the same as that of the plurality of the plaintext blocks;
encrypting the index block and the confusion blocks by a secret key with a second encryption method to generate an encrypted block; and
outputting a ciphertext, wherein the ciphertext comprises the encrypted block and the plurality of ciphertext blocks.

2. The hierarchical encryption method as claimed in claim 1, wherein the plaintext is a multimedia bitstream.

3. The hierarchical encryption method as claimed in claim 1, wherein the step of generating the plurality of mask blocks according to the plurality of confusion blocks and the index block further comprises:
calculating the corresponding value of each different address in the index block respectively to generate a calculated result to serve as an operation address for each confusion block;
obtaining the corresponding value of the operation address for each confusion block respectively according to the operation address; and
calculating the corresponding value for each confusion block respectively to generate a first value of each mask block by a specific formula.

4. The hierarchical encryption method as claimed in claim 1, wherein the complexity of the second encryption method is higher than that of the first encryption method.

5. The hierarchical encryption method as claimed in claim 1, further comprising:
decrypting the encrypted block by the secret key with a second decryption method corresponding to the second encryption method to generate the generated index block and the plurality of generated confusion blocks, and generating the plurality of generated mask blocks according to the generated index block and the plurality of generated confusion blocks, wherein the number of the plurality of generated confusion blocks is the same as that of the plurality of generated plaintext blocks; and
decrypting the plurality of ciphertext blocks by the plurality of generated confusion blocks with a first decryption method corresponding to the first encryption method to generate and output the plurality of generated plaintext blocks.

6. A hierarchical decryption method, comprising:
receiving a ciphertext, wherein the ciphertext comprises an encrypted block and a plurality of ciphertext blocks;
decrypting the encrypted block by a secret key with a second decryption method to generate at least one index block and a plurality of confusion blocks;
generating a plurality of mask blocks according to the plurality of confusion blocks and the index block, wherein the number of the plurality of mask blocks is the same as that of the plurality of ciphertext blocks;
decrypting the plurality of ciphertext blocks by the plurality of mask blocks with a first decryption method to generate a plurality of plaintext blocks, wherein the number of the plurality of plaintext blocks is the same as that of the plurality of ciphertext blocks; and
outputting a plaintext, wherein the plaintext comprises the plurality of plaintext blocks.

7. The hierarchical decryption method as claimed in claim 6, wherein the encrypted block is encrypted by a second encryption method corresponding to the second decryption method.

8. The hierarchical decryption method as claimed in claim 6, wherein the step of generating the plurality of mask blocks according to the plurality of confusion blocks and the index block further comprises:
calculating the corresponding value of each different address in the index block respectively to generate a calculated result to serve as an operation address for each confusion block;
obtaining the corresponding value of the operation address respectively for each confusion block according to the operation address; and
calculating the corresponding value for each confusion block respectively to generate a first value of each mask block by a specific formula.

9. A hierarchical encryption device, for encrypting a plaintext and outputting a ciphertext, wherein the plaintext is subdivided into a plurality of plaintext blocks according to a specific amount of data, comprising:
at least one index block, wherein the index block has a plurality of addresses and corresponding values, and the corresponding values of the plurality of addresses of the index block are randomly generated;
a plurality of confusion blocks, wherein the plurality of confusion blocks have a plurality of addresses and corresponding values, and the corresponding values of the plurality addresses in each confusion block are randomly generated;
a generator, for generating a plurality of mask blocks according to the index block and the plurality of confusion blocks, wherein the number of the plurality of mask blocks is the same as that of the plurality of plaintext blocks and each mask block has the specific amount of data;
a first encryption unit, for encrypting the plurality of plaintext blocks by the plurality of mask blocks to generate a plurality of ciphertext blocks; and
a second encryption unit, for encrypting the index block and the plurality of confusion blocks by a secret key with a second encryption method to generate an encrypted block, wherein the ciphertext comprises the encrypted block and the plurality of ciphertext blocks.

10. The hierarchical encryption device as claimed in claim 9, wherein the plaintext is a multimedia bitstream.

11. The hierarchical encryption device as claimed in claim 9, wherein before the step of generating the plurality of mask blocks according to the plurality of confusion blocks and the index block, the generator further performs the following steps:
calculating the corresponding value of each different address in the index block to generate a calculated result to serve as an operation address for each confusion block;
obtaining the corresponding values of the operation address for each confusion block according to the operation address; and
calculating the corresponding values for each confusion block to generate a first value of each mask block by a specific formula.

12. The hierarchical encryption device as claimed in claim 9, wherein the complexity of the second encryption method is higher than that of the first encryption method.

13. The hierarchical encryption device as claimed in claim 9, further comprising:
a second decryption unit, for decrypting the encrypted block by the secret key with a second decryption method corresponding to the second encryption method to generate the generated index block and the plurality of generated confusion blocks, wherein the generator further generates the plurality of generated mask blocks according to the generated index block and the plurality of generated confusion blocks, wherein the number of the plurality of generated mask blocks is the same as that of the plurality of generated plaintext blocks; and
a first decryption unit, for decrypting the plurality of ciphertext blocks by the plurality of generated mask blocks with a first decryption method corresponding to the first encryption method to generate and output the plurality of generated plaintext blocks.

14. A hierarchical decryption device, for decrypting a ciphertext and outputting a plaintext, wherein the ciphertext comprises an encrypted block and a plurality of ciphertext blocks, comprising:
a second decryption unit, for decrypting the encrypted block by a secret key with a second decryption method to generate at least one index block and a plurality of confusion blocks;
a generator, for generating a plurality of mask blocks according to the plurality of confusion blocks and the index block, wherein the number of the plurality of mask blocks is the same as that of the plurality of ciphertext blocks; and
a first decryption unit, for decrypting the plurality of ciphertext blocks by the plurality of mask blocks with a first decryption method to generate a plurality of plaintext blocks, wherein the number of the plurality of plaintext blocks is the same as that of the plurality of ciphertext blocks.

15. The hierarchical decryption device as claimed in claim 14, wherein the encrypted block is encrypted by a second encryption method corresponding to the second decryption method.

16. The hierarchical decryption device as claimed in claim 14, wherein before the step of generating the plurality of mask blocks according to the plurality of confusion blocks and the index block, the generator further performs the following steps:
calculating the corresponding value of each different address in the index block to generate a calculated result to serve as an operation address for each confusion block;
obtaining the corresponding values of the operation address for each confusion block according to the operation address; and
calculating the corresponding values for each confusion block to generate a first value of each mask block by a specific formula.
